(19) United States
(12) Patent Application Publication
(10) Pub. No.: US 2024/0344177 A1
(43) Pub. Date: Oct. 17, 2024

(54) METHOD FOR RECOVERING GERMANIUM

(71) Applicant: SUMITOMO ELECTRIC INDUSTRIES, LTD., Osaka (JP)

(72) Inventors: Toshimi HABASAKI, Tochigi (JP); Kiichi KIMURA, Osaka (JP); Masanori SHIMURA, Tochigi (JP)

(21) Appl. No.: 18/755,816

(22) Filed: Jun. 27, 2024

(30) Foreign Application Priority Data
Jul. 5, 2023 (JP) 2023-110528

(51) Int. Cl. C22B 41/00; B01D 53/38; B01D 53/78

(52) U.S. Cl. CPC C22B 41/00; B01D 53/38; B01D 53/78; B01D 2257/55; B01D 2258/0241

(57) ABSTRACT

A method for recovering germanium from exhaust gas, includes: a first step of bringing the exhaust gas into contact with circulating water to move germanium; a second step of supplying the circulating water and a soluble iron salt to a reception tank; a third step of neutralizing the circulating water; and a fourth step of settling a precipitate in the circulating water. The first step to the fourth step are set as one cycle and are repeatedly executed in two or more cycles. In the second step of a second or subsequent cycle, at least a part of the precipitate obtained as the soluble iron salt in the fourth step is injected into the reception tank. The precipitate is taken out after executing the first step to the fourth step in a predetermined number of cycles.

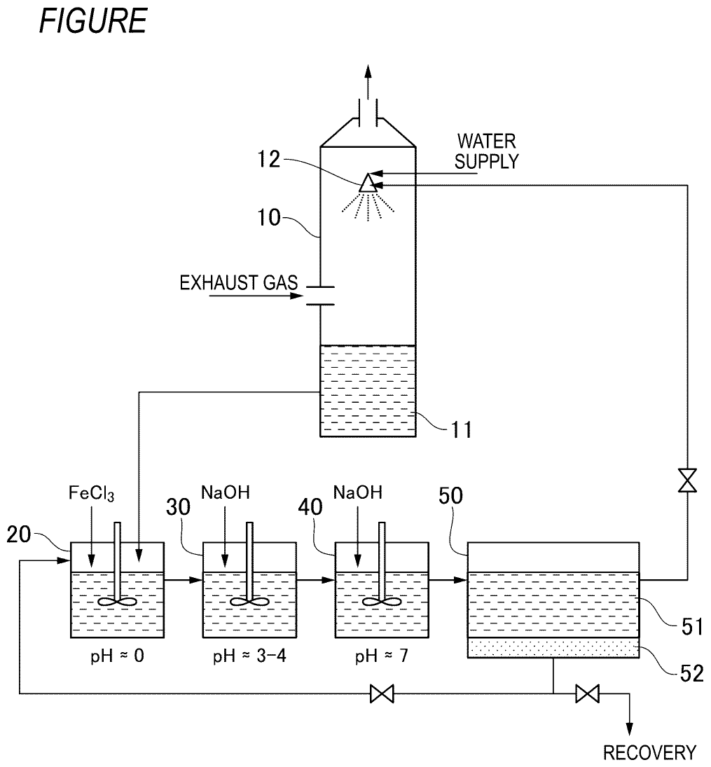

### TECHNICAL FIELD

The present disclosure relates to a method for recovering germanium. This application claims priority based on Japanese Patent Application No. 2023-110528 filed on Jul. 5, 2023, and the entire contents of which are incorporated herein by reference.

### BACKGROUND ART

Germanium is used as an additive of an optical fiber. Since germanium is expensive, a

method for recovering germanium from gas exhausted during manufacturing of a preform for an optical fiber is investigated. JP2001-58823A discloses a recovery method of allowing MCVD processing wastes to react with hydrogen chloride gas to form germanium tetrachloride. JP2002-512560A discloses a method of adding magnesium oxide to wastewater including germanium to precipitate germanium.

### SUMMARY

According to the present disclosure, there is a method for recovering germanium from exhaust gas exhausted during manufacturing of a preform for an optical fiber, the exhaust gas including acidic exhaust gas, and the method including: a first step of bringing the exhaust gas into contact with circulating water of a cooling tower to move germanium in the exhaust gas into the circulating water; a second step of supplying the circulating water and a soluble iron salt to a reception tank after the first step; a third step of neutralizing the circulating water after the second step; and a fourth step of settling a precipitate in the circulating water after the third step, in which the first step to the fourth step are set as one cycle and are repeatedly executed in two or more cycles, in the second step of a second or subsequent cycle, at least a part of the precipitate obtained as the soluble iron salt in the fourth step is injected into the reception tank, and the precipitate is taken out after executing the first step to the fourth step in a predetermined number of cycles.

### BRIEF DESCRIPTION OF DRAWING(S)

FIGURE is a diagram schematically illustrating a method for recovering germanium according to an embodiment of the present disclosure.

### DESCRIPTION OF EMBODIMENTS

After allowing gas exhausted in a manufacturing step of a preform for an optical fiber to pass through a cooling tower to cool the gas, a treatment such as dust collection or filtration is executed. When the exhaust gas passes through the cooling tower, a part of germanium in the exhaust gas moves into circulating water that circulates in the cooling tower. However, the concentration of germanium in the circulating water is low, and in consideration of a cost required for recovery, it is difficult to recover germanium from the circulating water of the cooling tower.

An object of the present disclosure is to provide a method for recovering germanium in a manufacturing step of a preform for an optical fiber.

According to the present disclosure, a method for recovering germanium in a manufacturing step of a preform for an optical fiber can be provided.

### DESCRIPTION OF EMBODIMENT OF PRESENT DISCLOSURE

First, an embodiment of the present disclosure will be described. A method for recovering germanium according to one embodiment of the present disclosure is
(1) a method for recovering germanium from exhaust gas exhausted during manufacturing of a preform for an optical fiber,
the exhaust gas including acidic exhaust gas, and
the method including:
a first step of bringing the exhaust gas into contact with circulating water of a cooling tower to move germanium in the exhaust gas into the circulating water;
a second step of supplying the circulating water and a soluble iron salt to a reception tank after the first step;
a third step of neutralizing the circulating water after the second step; and
a fourth step of settling a precipitate in the circulating water after the third step,
in which the first step to the fourth step are set as one cycle and are repeatedly executed in two or more cycles,
in the second step of a second or subsequent cycle, at least a part of the precipitate obtained as the soluble iron salt in the fourth step is injected into the reception tank, and
the precipitate is taken out after executing the first step to the fourth step in a predetermined number of cycles.

In the present embodiment, germanium can be recovered from the circulating water of the cooling tower.
(2) In the method for recovering germanium according to (1), the soluble iron salt to be injected in the second step of a first cycle is ferrous chloride or ferric chloride.

Ferrous chloride or ferric chloride is easy to handle. In addition, the circulating water of the cooling tower includes hydrochloric acid. Therefore, by using the chloride, incorporation of foreign ions can be prevented when a supernatant liquid returns to the cooling tower.
(3) In the method for recovering germanium according to (1) or (2), in the third step, a base is injected dividedly in two stages to neutralize the circulating water.

By executing the neutralization in two stages, the pH can be easily adjusted, and coprecipitation of germanium is likely to occur.

### DETAILS OF EMBODIMENT OF PRESENT DISCLOSURE

Hereinafter, a specific example of a method for recovering germanium according to the present disclosure will be described with reference to the drawings. The present invention is not limited to these examples and is intended to include any modifications within the scope and meaning equivalent to the terms of the claims.

FIGURE is a schematic diagram illustrating a flow of a method for recovering germanium according to one embodiment of the present disclosure. A cooling tower 10 is a device that cools and cleans exhaust gas exhausted from a heating furnace during manufacturing of a preform for an optical fiber. As the cooling tower 10, any kind of scrubber can be used. FIGURE illustrates a shower type scrubber. Circulating water 11 is circulated in the cooling tower 10. The circulating water 11 is sprayed from a nozzle 12 on the upper side of the cooling tower 10 to cool and clean the exhaust gas passing through the cooling tower 10. The cooled exhaust gas is exhausted from an exhaust port provided in an upper portion of the cooling tower 10, and is supplied to another exhaust gas treatment device such as an electric dust collector.

The exhaust gas includes acidic exhaust gas. The acidic exhaust gas is chlorine (Cl₂) gas or hydrogen chloride (HCl) gas. Examples of the exhaust gas including the acidic exhaust gas include exhaust gas exhausted in a step of depositing glass particles synthesized in a gas phase to manufacture a porous preform and exhaust gas exhausted in a dehydration step of a porous preform.

During manufacturing of preform for an optical fiber, a germanium raw material such

as germanium tetrachloride is used. A part of germanium to be used is exhausted together with the exhaust gas without being incorporated into the preform for an optical fiber. By allowing the exhaust gas to pass through the cooling tower 10, germanium in the exhaust gas moves to the circulating water 11 (first step). That is, the circulating water 11 is a liquid including germanium. Due to the effect of chlorine or hydrogen chloride in the exhaust gas, the circulating water 11 is strongly acidic at a pH of about 0.

Next, the circulating water 11 including germanium is taken out from the cooling tower 10 and supplied to a reception tank 20. Further, ferric chloride as a soluble iron salt is supplied to the reception tank 20 (second step). In the second step, the soluble iron salt may be supplied after supplying the circulating water 11 to the reception tank 20, the circulating water 11 may be supplied after supplying the soluble iron salt, and the circulating water 11 and the soluble iron salt may be supplied simultaneously. The soluble iron salt in the present disclosure is a salt including iron ions, and refers to a salt that is dissolved when injected into the circulating water 11 of the reception tank 20 at about pH=0. The valence of the iron ions is not limited and is typically divalent or trivalent. The soluble iron salt is injected for coprecipitation of germanium described below. The soluble iron salt is not limited to ferric chloride, and ferrous chloride or iron halide, iron sulfate, or iron nitrate other than a chloride may be used. The soluble iron salt may be injected in a solution state or in a solid state. The soluble iron salt may be soluble in neutral water. When the soluble iron salt is soluble in neutral water, the soluble iron salt can be injected in an aqueous solution state. Therefore, the soluble iron salt is easy to handle. The examples of the soluble iron salt described above are examples for a first cycle. However, as the soluble iron salt to be injected in the second step of a second or subsequent cycle, a precipitate 52 obtained in a fourth step is injected as described below.

Next, the circulating water 11 moves from the reception tank 20 to a first neutralization tank 30, and a base such as a sodium hydroxide aqueous solution is injected to the first neutralization tank 30. In the first neutralization tank 30, the circulating water 11 is adjusted to be moderately acidic (for example, a pH of 3 to 4).

Next, the circulating water 11 moves from the first neutralization tank 30 to a second neutralization tank 40. In the second neutralization tank 40, a base such as a sodium hydroxide aqueous solution is further injected to neutralize the circulating water 11, and is adjusted such that the pH is neutral at about 7 (third step). By adjusting the circulating water 11 to be neutral, insoluble iron hydroxide is formed and precipitated. At this time, not only the precipitation of iron hydroxide but also coprecipitation of germanium occur. In the present embodiment, the neutralization in the third step is executed in two stages. Therefore, the pH of the circulating water 11 is easily adjusted. In addition, by executing the neutralization in two stages, the precipitation of iron hydroxide gently occurs, and thus the coprecipitation of germanium is likely to occur.

Next, the circulating water 11 of the second neutralization tank 40 moves to a settling tank 50, and the precipitate 52 is settled (fourth step). The circulating water 11 where the precipitate 52 is settled is in a state where the precipitate 52 of the lower layer and a supernatant liquid 51 of the upper layer are separated.

The supernatant liquid 51 may return to the cooling tower 10 to be used as the circulating water 11 again. As a result, the amount of the circulating water 11 used can be reduced. The supernatant liquid 51 may be used as circulating water of another exhaust gas treatment device such as an electric dust collector.

Through the first step to the fourth step described above, the precipitate 52 including germanium is obtained. However, in a stage where the first step to the fourth step are executed once, the amount of germanium in the precipitate 52 is small. Therefore, even when it is attempted to recover germanium from the precipitate 52 in this stage, the amount of germanium recovered is insufficient for the recovery cost.

Accordingly, in the present embodiment, the first step to the fourth step described above are set as one cycle, and these steps are repeatedly executed in two or more cycles.

Specifically, the exhaust gas exhausted again from the heating furnace during manufacturing of the preform for an optical fiber is brought into contact with the circulating water 11 of the cooling tower 10 to move germanium in the exhaust gas to the circulating water 11 (first step). Next, the circulating water 11 is supplied to the reception tank 20. The circulating water 11 that is newly supplied to the reception tank 20 includes the same concentration of germanium as the circulating water 11 supplied in the first cycle. Further, the soluble iron salt is injected to the reception tank 20 (second step). Note that, in the second step of the second or subsequent cycle, at least a part of the precipitate 52 formed in the fourth step is injected to the reception tank 20 as the soluble iron salt. A major component of the precipitate 52 is iron hydroxide, and the precipitate is settled under the neutral condition. However, the precipitate 52 is dissolved when injected into the circulating water 11 of the reception tank 20 that is strongly acidic at about pH=0.

Next, as in the first cycle, the neutralization in the first neutralization tank 30 and the second neutralization tank 40 is executed (third step), and the precipitate 52 is settled in the settling tank 50 (fourth step). At this time, the amount of iron hydroxide in the precipitate 52 is the same as that of the first cycle, whereas the amount of germanium in the precipitate 52 corresponds to two cycles. This way, by executing the second cycle, the concentration of germanium in the precipitate 52 can be increased.

By repeating the same cycle as the second cycle, the concentration of germanium in the precipitate 52 can be further increased.

In the above description, an aspect where the next cycle starts after ending one cycle consisting of the first step to fourth step is described. However, two or more steps among the first step to the fourth step may be executed in parallel. For example, an aspect may be adopted where an operation of circulating the circulating water 11 such that the circulating water 11 is taken out from the cooling tower 10 for the neutralization and settlement and subsequently the supernatant liquid of the settling tank 50 returns to the cooling tower 10 again and an operation of taking out the precipitate 52 along with the circulation of the circulating water 11 and injecting the precipitate 52 to the reception tank 20 are continuously executed. By executing two or more steps in parallel, germanium can be efficiently extracted from the circulating water 11. When two or more steps are executed in parallel, one cycle is defined as a period required until the soluble iron salt injected to the reception tank 20 precipitates as the precipitate 52 settled in the settling tank 50 and is injected to the reception tank 20 again. More specifically, a period required until the amount of the circulating water 11 injected to the reception tank 20 at a certain time is the same as the sum of the volume of the reception tank, the volume of the neutralization tank, and the volume of the settling tank is defined as one cycle.

After executing a predetermined number of cycles, the precipitate 52 is taken out from the settling tank 50. The precipitate 52 that is taken out includes a high concentration of germanium. The precipitate 52 that is taken out is provided for a dehydration treatment of a filter press to form a cake. As a result, the amount of germanium that is sufficient for the recover cost can be recovered.

A timing at which the repetition of the cycles ends and the precipitate 52 is taken out can be freely set. For example, when the settlement in the settling tank 50 is not sufficiently completed such that, for example, a situation where the supernatant liquid 51 becomes turbid, a situation where a long time is required for the settlement, or a situation where the treatment efficiency decreases due to accumulation of impurity such as silica occurs, it can be considered to take out the precipitate 52. Alternatively, by previously calculating the number of cycles in a range where the settlement is sufficiently completed or the number of cycles in a range where the concentration of germanium in the precipitate 52 that is sufficient for the recover cost is obtained, it can be considered to take out the precipitate 52 after executing the previously calculated number of cycles. When the operation of circulating the circulating water 11 and the operation of taking out the precipitate 52 and injecting the precipitate 52 to the reception tank 20 are continuously executed, the precipitate 52 may be taken out after a predetermined operating time elapses.

### EXAMPLES

A preliminary experiment was executed to verify the effect of the method for recovering germanium according to the present embodiment. Specifically, exhaust gas exhausted from a heating furnace for manufacturing a porous preform for an optical fiber was allowed to pass through a cooling tower, circulating water was taken out from the cooling tower, and the following procedures (A) to (I) were executed.
(A) The concentration of germanium in the circulating water was measured.
(B) Ferric chloride was added to a container containing 80 L of circulating water.
(C) A sodium hydroxide aqueous solution was added to the container of (B) for neutralization such that the pH was about 7. At this time, a red-brown precipitate including iron hydroxide as a major component was formed in the container.
(D) The precipitate in the container of (C) was settled, a supernatant liquid was collected, and the concentration of germanium in the supernatant liquid was measured. In addition, after a part of the precipitate was collected and dehydrated, the concentration of germanium in the precipitate liquid was measured.
(E) Only the precipitate of (D) was allows to remain, and all of the supernatant liquid was removed.
(F) 80 L of circulating water was newly taken out from the cooling tower and was added to the container of (E) containing the precipitate to dissolve the precipitate.
(G) A sodium hydroxide aqueous solution was added to the container of (F) for neutralization, and the precipitate was settled.
(H) (E) to (G) were further repeated five times. In the fourth cycle, the supernatant liquid was collected, and the concentration of germanium in the supernatant liquid was measured. In addition, after a part of the precipitate was collected and dehydrated, the concentration of germanium in the precipitate was measured.
(I) Finally, the supernatant liquid was collected, and the concentration of germanium in the supernatant liquid was measured. In addition, after the precipitate settled in the container was taken out and dehydrated, the amount of germanium in the precipitate was measured. That is, in the present preliminary experiment, the same procedures as those of a case where the first step to the fourth step were executed in 7 cycles was executed. The total amount of the circulating water taken out from the cooling tower was 560 L.

Table 1 shows the analysis results of the amounts of germanium in the circulating water of the cooling tower and the supernatant liquids of the first cycle, the fourth cycle, and the seventh cycle (represented by Supernatant Liquid 1, Supernatant Liquid 4, and Supernatant Liquid 7, respectively). In addition, Table 2 shows the analysis results of the amounts of germanium in samples obtained by dehydrating the precipitates of the first cycle, the fourth cycle, and the seventh cycle (represented by Dehydrated Sample 1, Dehydrated Sample 4, and Dehydrated Sample 7, respectively).

TABLE 1

| Sample | Ge Concentration (mg/L) |
|---|---|
| Circulating Water of Cooling Tower | 12.7 |
| Supernatant Liquid 1 | 0.0 |
| Supernatant Liquid 4 | 0.0 |
| Supernatant Liquid 7 | 0.0 |

TABLE 2

| Sample | Ge Concentration (mg/g) |
|---|---|
| Dehydrated Sample 1 | 90 |
| Dehydrated Sample 4 | 170 |
| Dehydrated Sample 7 | 250 |

As can be seen from the results of Tables 1 and 2, all of the neutralized supernatant liquids did not include germanium, and the samples obtained by dehydrating the precipitates included germanium. In addition, it was able to be verified that, in the samples obtained by dehydrating the precipitates, as the number of cycles increased, the concentration of germanium increased. It was found from the above result that germanium in the circulating water was concentrated using the method and was able to be efficiently recovered.

Hereinabove, the method for recovering germanium according to the present disclosure is described using the specific examples. However, the present disclosure is not limited to this aspect.

The method for recovering germanium according to the present disclosure is also applicable to all of methods for manufacturing an optical fiber preform in which exhaust gas includes germanium, for example, to a VAD method, an MCVD method, or an OVD method.

In the above-described embodiment, the neutralization in the third step is executed in two stages. However, the neutralization may be executed in one stage. That is, one neutralization tank may be provided. By executing the neutralization in one stage, the device cost can be reduced.

In the second step of the second or subsequent cycle, as necessary, a soluble iron salt may be newly injected to the reception tank in addition to the precipitate formed in the fourth step. Note that, in order to avoid a decrease in the concentration of germanium in the precipitate, it is preferable to minimize the amount of the soluble iron salt that is newly injected in the second or subsequent cycle.

1. A method for recovering germanium from exhaust gas exhausted during manufacturing of a preform for an optical fiber,
the exhaust gas including acidic exhaust gas, and
the method comprising:
a first step of bringing the exhaust gas into contact with circulating water of a cooling tower to move germanium in the exhaust gas into the circulating water;
a second step of supplying the circulating water and a soluble iron salt to a reception tank after the first step;
a third step of neutralizing the circulating water after the second step; and
a fourth step of settling a precipitate in the circulating water after the third step,
wherein the first step to the fourth step are set as one cycle and are repeatedly executed in two or more cycles,
in the second step of a second or subsequent cycle, at least a part of the precipitate obtained as the soluble iron salt in the fourth step is injected into the reception tank, and
the precipitate is taken out after executing the first step to the fourth step in a predetermined number of cycles.

2. The method for recovering germanium according to claim 1,
wherein the soluble iron salt to be injected in the second step of a first cycle is ferrous chloride or ferric chloride.

3. The method for recovering germanium according to claim 1,
wherein in the third step, a base is injected dividedly in two stages to neutralize the circulating water.

4. The method for recovering germanium according to claim 2,
wherein in the third step, a base is injected dividedly in two stages to neutralize the circulating water.

5. A method for recovering germanium from exhaust gas exhausted during manufacturing of a preform for an optical fiber, the method comprising:
a first step of bringing the exhaust gas into contact with circulating water of a cooling tower to move germanium in the exhaust gas into the circulating water; and
a second step of supplying the circulating water and a soluble iron salt to a reception tank after the first step.
